(19) United States
(12) Patent Application Publication
(10) Pub. No.: US 2007/0022012 A1
(43) Pub. Date: Jan. 25, 2007

(54) RFID access apparatus and a transaction method using the same

(75) Inventors: Bo-Chen Wu, Hsinchu City 300 (TW); Bing-Chen Kuo, Hsinchu City 300 (TW); Ming-Hsiu Hsu, Nantou City (TW); Ya-Ping Chen, Hsinchu City 300 (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/224,974

(22) Filed: Sep. 14, 2005

(30) Foreign Application Priority Data
Jul. 22, 2005 (TW) 94124817

(51) Int. Cl. G06Q 20/00

(52) U.S. Cl. 705/20

(57) ABSTRACT

The present invention discloses a RFID access apparatus and a Transaction method using the same. The RFID access apparatus, coupled to a SD card socket disposed in an electrical terminal device including a controller unit coupled to said SD card socket and a radio frequency transceiver coupled to said controller unit, and being capable of accessing data recorded in a RFID tag through operating said electrical terminal device, comprising: a SD interface, coupled to said SD card socket for signal and data communication; a radio frequency access unit, coupled to said SD interface for reading data recorded in said RFID tag and writing data into said RFID tag; and a memory unit, coupled to said SD interface for storing data. By using the RFID access apparatus, a transaction method can be performed in the following steps: providing an electrical terminal device comprising a SD card socket; inserting a RFID access apparatus, comprising a memory unit recording an electric currency, into said SD card socket; accessing a price, stored in a RFID tag attached on a product, by operating said electrical terminal device; and making transaction.

### FIELD OF THE INVENTION

The present invention relates to a RFID access apparatus and a transaction method using the same. More particularly, the present invention relates to utilize a RFID access apparatus having Secure Digital interface and operating in a bandwidth of ultra high frequency; meanwhile the present invention also relates to provide a transaction method that utilizes the RFID access apparatus to purchase a product having a RFID tag.

### BACKGROUND OF THE INVENTION

Radio Frequency Identification technology, a cutting edge technique of wireless system in the century, has gradually change the managing and consuming ways for human beings. RFID system can automatically identify tracks and manages objects via a fast connection between the object and RFID reader. With many advantages comparing to the conventional managing way, RFID system can be adopted in the categories such as aviation baggage management control, automatic production control, warehouse storage control, transportation control, security control, library control, consuming product control, electric financial control and so on. Hence, soon after the future, RFID is capable of replacing the conventional managing ways such as barcode management system.

In mobile communication fields, mobile devices with RFID functionalities such as a RFID tag deposed in the mobile devices or a RFID reader/writer deposed in the mobile devices to complete RFID identification mechanism have been disclosed in the prior arts or patents extensively.

Taking U.S. Pat. No. 6,892,052 for an instance, that discloses a mobile device having RFID reader module and RFID tag and adopting near field communication as a basic communication protocol.

Others such as US2003/0120745 has disclosed an information receiving system which allows user acquisition of product information from a server over a network and displays of the information without awaiting the user's instructions by using an information receiving terminal to access RFID tag attached on the product through radio frequencies.

However, according to the foregoing prior arts, we can conclude the following shortcomings:
(1) The prior arts are limited to the long distance communication because of those devices adopting the low frequency or high frequency as transmitting media.
(2) The RFID readers of the prior arts are built inside the mobile devices so that the user could not connect or remove the RFID reader according to using circumstances.

Besides, U.S. Pat. No. 5,729,591 also discloses an apparatus of a cellular telephone allowing the cellular telephone to accept input from a credit card-like device. Since the card reader device is attached on the cellular telephone, it is inconvenient to user due to its bulk and additional credit card taking.

Hence, it is necessary to develop a RFID access apparatus and a transaction method using the same to overcome the drawbacks of the foregoing prior arts.

### SUMMARY OF THE INVENTION

A primary object of the present invention is to utilize a RFID access apparatus coupled to an electrical terminal device so as to achieve an objective of plug-and-play so that user can easily decide circumstances whether to use or not.

Another object of the present invention is to provide a RFID access apparatus whose communication bandwidth is ultra high frequency so as to broaden the communication and accessing range.

A further object of the present invention is to provide a transaction method utilizing the RFID access apparatus for consuming products with RFID tags so as to achieve an objective of electric shopping.

For the purpose to achieve the foregoing objectives, the prevent invention discloses a RFID access apparatus, coupled to a SD card socket disposed in an electrical terminal device including a controller unit coupled to the SD card socket and a radio frequency transceiver coupled to the controller unit, and being capable of accessing data recorded in a RFID tag through operating the electrical terminal device, comprising: a SD interface, coupled to the SD card socket for signal and data communication; a radio frequency access unit, coupled to the SD interface for reading data recorded in the RFID tag and writing data into the RFID tag; and a memory unit, coupled to the SD interface for storing data.

Preferably, the radio frequency access unit is capable of reading and writing the RFID tag through radio frequency emitted from the radio frequency transceiver.

Preferably, the RFID access apparatus further comprises an radio frequency transceiver coupled to the SD interface for transmitting and receiving ultra high frequency signals to access the RFID tag.

Preferably, the electrical terminal device is a mobile phone.

Preferably, the electrical terminal device is a personal assistant device.

Preferably, the data stored in the memory unit further comprises an electric currency.

For the purpose to achieve the foregoing objectives, the prevent invention discloses a transaction method using the RFID access apparatus, being capable of purchasing a product having a RFID tag, comprising the steps of: providing an electrical terminal device comprising a SD card socket; inserting a RFID access apparatus, comprising a memory unit recording an electric currency, into said SD card socket; accessing a price, stored in a RFID tag attached on a product, by operating said electrical terminal device; and making transaction.

### BRIEF DESCRIPTION OF THE DRAWINGS

FIG. 1a is a schematic illustration of a RFID access apparatus, a first preferred embodiment according to the present invention, coupled to an electrical terminal device.

FIG. 1b is a schematic illustration of a RFID access apparatus that is a second preferred embodiment according to the present invention.

FIG. 2 is a first embodiment that illustrates the RFID access apparatus according the present invention accessing the RFID tag attached on a product.

FIG. 3 illustrates a transaction flow by utilizing the first preferred embodiment of the RFID access apparatus.

FIG. 4 is an embodiment of the step of making transaction according to the process flow of FIG. 3.

FIG. 5 illustrates a transaction flow by utilizing the second preferred embodiment of the RFID access apparatus.

FIG. 6 is an embodiment of the step of making transaction according to the process flow of FIG. 5.

### DESCRIPTION OF THE PREFERRED EMBODIMENT

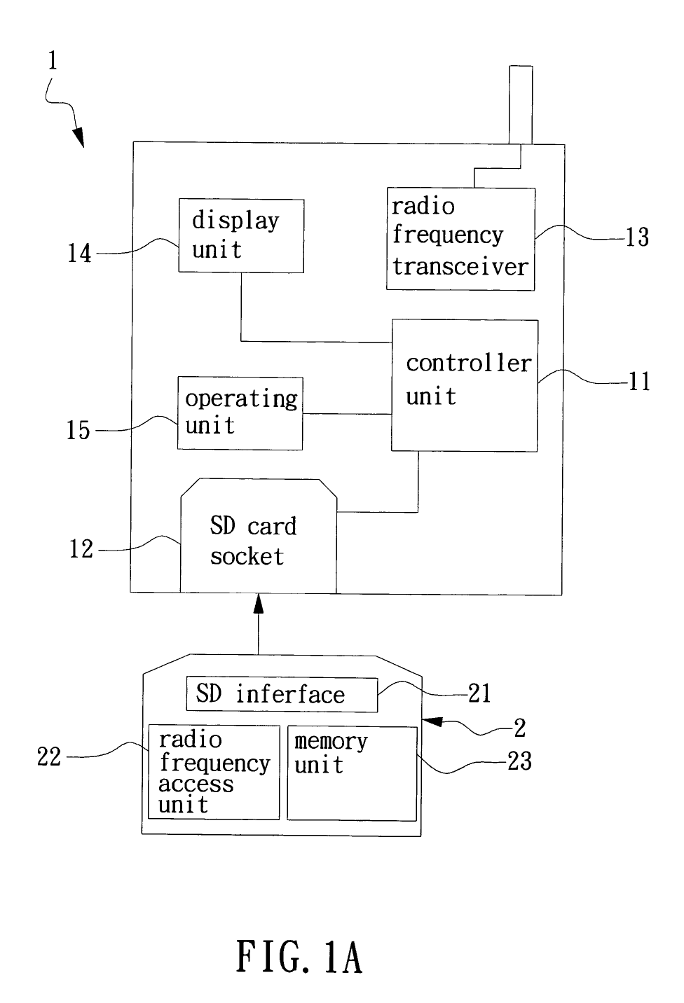

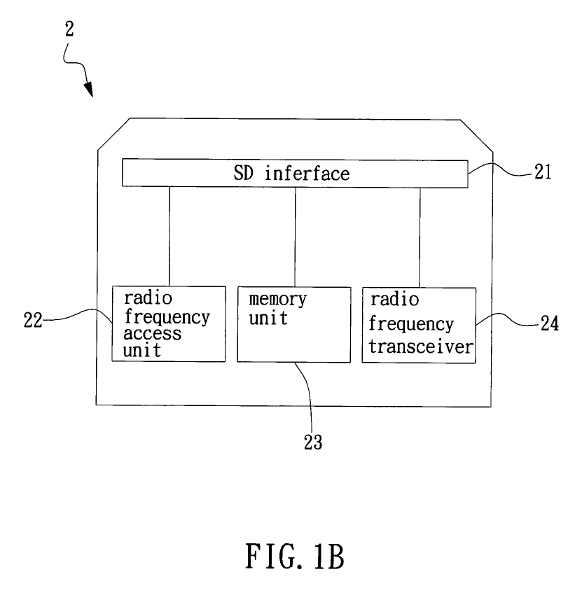

FIG. 1a, a schematic illustration of a RFID access apparatus coupled to an electrical terminal device, is shown that a RFID access apparatus 2 coupled to a SD card socket 12 disposed in an electrical terminal device 1 including a controller unit 11 coupled to the SD card socket 12, a radio frequency transceiver 13 coupled to the controller unit 11, a display unit 14 coupled to the controller unit 11, and a operating unit 15 coupled to the controller unit 11. The users can control the RFID access apparatus 2 to read the data stored in a RFID tag or write data into the RFID tag through the operating unit 15 to control the electrical terminal devices 1. The electrical terminal device 1, for example, can be a personal digital assistant or cellular phone.

The RFID access apparatus 2 comprises a SD interface 21, a radio frequency access unit 22 and a memory unit 23. The SD interface 21 is coupled to the SD card socket 12 for signal and data communication. The radio frequency access unit 22 is coupled to the SD interface 21 for reading data recorded in the RFID tag and writing data into the RFID tag, and the memory unit 23 is coupled to the SD interface 21 for storing data such as an electric currency for electric transaction or trading, personal information, trading date and so on.

The RFID access apparatus 2 is inserted into the SD card socket 12 to couple to the electrical terminal device 1 and is capable of performing the ability of hot plugging. In this embodiment, the RFID access apparatus 2 transmits and receives radio frequency signals via the radio frequency transceiver 13 of the electrical terminal device 1 using ultra high frequency, i.e. 860M˜930 MHz as its communication medium to access the RFID tag for the purpose of enlarging the communication distance.

FIG. 1b is another embodiment of a RFID access apparatus 2 further comprising a radio frequency transceiver 24 coupled to the SD interface 21 for transmitting and receiving ultra high frequency signals to access the RFID tag.

Returning the FIG. 1a, when user wants to operate the RFID access apparatus 2, it is simple to insert the RFID apparatus 2 into the SD card socket 12 of the electrical terminal device 1. The user can easily read data from the RFID tag or store the data into the RFID tag by manipulating the operating unit 15 making the controller unit 11 to control the RFID access apparatus 2. Since the communication bandwidth of the RFID access apparatus 2 is ultra high frequency, the transmission and communication distance is becoming longer; on the other hand, due to the SD communication mechanism, user can plug or pull out the RFID access apparatus 2 depending on circumstances. If the user doesn't use the RFID access apparatus 2, they can pull it out from the SD socket 12; therefore it is not necessary to worry about that the security problem such as data stored in the memory unit 23 is stolen when the electrical terminal device 1 is lost.

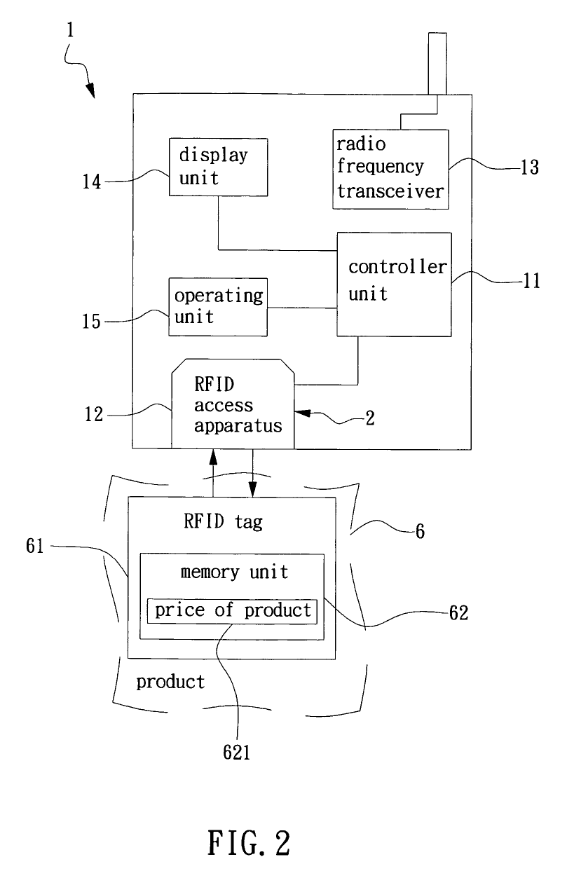

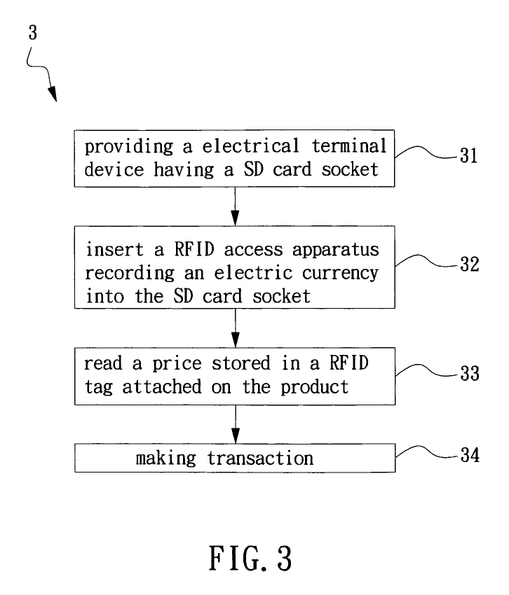

Referring to FIG. 2 and FIG. 3, wherein FIG. 2 refers to a RFID access apparatus according to the first preferred embodiment of the present invention to access a RFID tag of a product, and FIG. 3 refers to a transaction flow by utilizing the first preferred embodiment of the RFID access apparatus.

The present invention provide a transaction method using RFID access apparatus 2, being capable of purchasing a product 6 having a RFID tag 61, comprising the steps of following: at first processing the step 31 to provide a SD card socket disposed in an electrical terminal device 1 including a controller unit 11 coupled to the SD card socket 12 and a radio frequency transceiver 13 coupled to the controller unit 11. Then, as illustrated in step 32, providing a RFID access apparatus 2 comprises a memory unit recording an electric currency, coupled to the SD card socket 12. Thereafter, user operates the electrical terminal device 1 to read a price 621, stored in a RFID tag 61 attached on a product 6. Finally, the transaction is processed.

The RFID access apparatus 2 recorded the electric currency making the RFID access apparatus 2 have functionality similar to a stored value card, in other words, the user can stored an amount of money into the RFID access apparatus 2 to consume products in way of electrical trading. By means of step 31 and step 32, the electrical terminal device 1 becomes a device that is capable of consuming the product 6 having the RFID tag 61 which records price 621 in its memory unit 62. After user manipulates the electrical terminal device 1 to retrieve the price 621 recorded in the RFID tag 61 of the product 6, the electrical terminal device 1 will process the transaction.

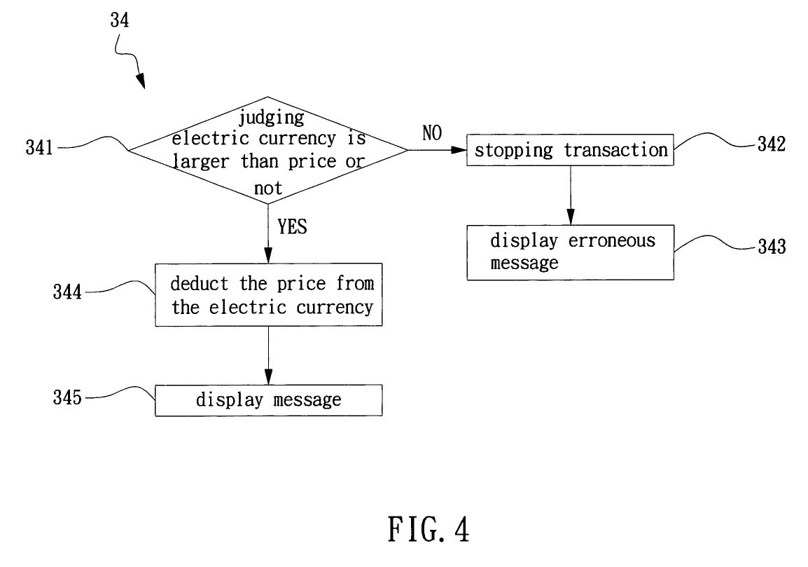

Referring to FIG. 4, which is an embodiment of the step of making transaction according to the process flow of FIG. 3. After retrieving the price 621 of the product 6, the electrical terminal device 1 will judge whether the electric currency stored in the RFID access apparatus 2 is larger than the price 621 or not, illustrated as step 341. If the electric currency is larger than the price, then the electrical terminal device 1 will deduct the price from the electric currency, illustrated as step 344. After that, the display unit of the electrical terminal device 1 will display successful trading message and the residual of said electric currency on the display unit 14 of the electrical terminal device 1, which is illustrated as step 345. If the electric currency stored in the RFID access apparatus 2 is not enough to consume the product 6, the electrical terminal device 1 will proceed the step 342 to stop the transaction and then display the error message of transaction fail on the display unit 14 of the electrical terminal device, illustrated as the step 343.

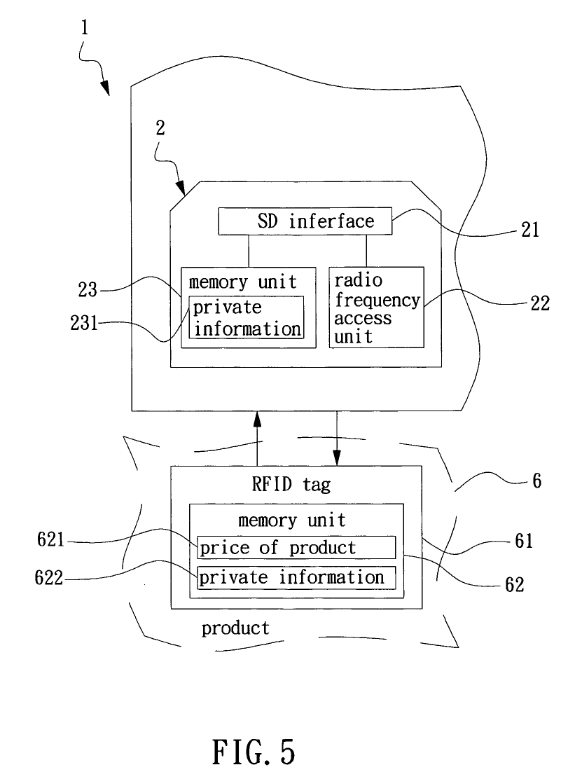

FIG. 5 shows a transaction flow by utilizing the second preferred embodiment of the RFID access apparatus. In this embodiment, the memory unit 23 of the RFID access apparatus 2 further records private information 231 of user such as user name, identification number, address, or phone number, for example.

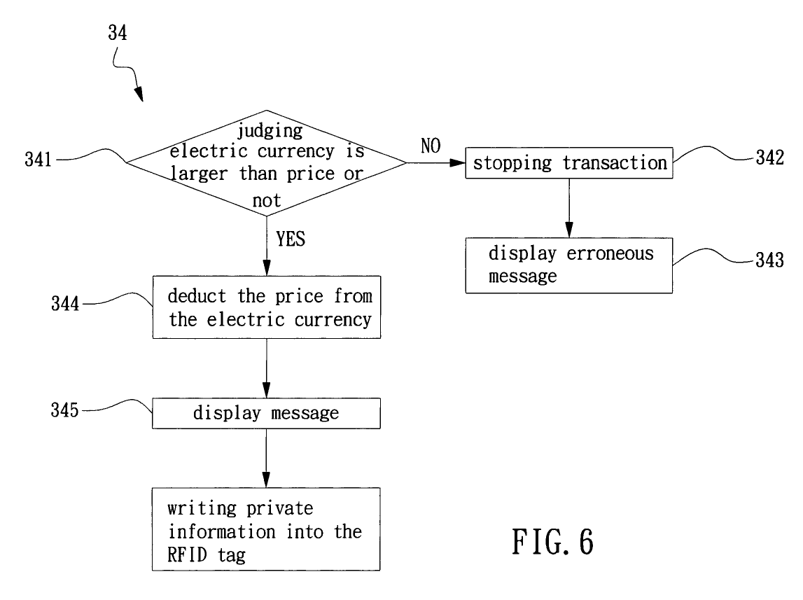

FIG. 6 illustrates an embodiment of the step of making transaction according to the process flow of FIG. 5. In this embodiment, the transaction flow further comprises a step 346 of the electrical terminal device 1 controlling the RFID access apparatus 2 to write the private information 231 of user to the RFID tag 61 attached on the product 6 after step 346. Referring to FIG. 5, the memory unit 62 of the RFID tag 61 attached on the product 6 will increase a new data related to the private information 622 of user.

The step 346 can make sure a security procedure once the product purchased by the user is lost. If the product is found, the product can be identified immediately according to the data recorded in the RFID tag of the product to confirm who is the owner of the product. In cases of the user found a suspect product that might belongs to the user, he or she can operate the electrical terminal device to retrieve the data of private information recorded in the RFID tag attached on the suspect product to confirm whether the suspect product is the one he or she lost or not. Besides, the private information of user is also available to be used as the identification of the product service so that the user and maker can both gain the benefits with each other. For example, the consuming date can be recorded into the RFID tag after the user purchases the product. Once the product has problem, the service center of the maker can easily recognize the product to confirm whether the guarantee of the product is expired or not.

The RFID access apparatus and transaction method according to the present invention provide many conveniences for users to consume products without cashes. Meanwhile users who use RFID access apparatus and transaction method according to the present invention can avoid credit card skimming while making transaction.

While the invention has been described with reference to various illustrative embodiments, the description is not intended to be construed in a limiting scope. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A RFID access apparatus, coupled to a SD card socket disposed in an electrical terminal device including a controller unit coupled to said SD card socket and a radio frequency transceiver coupled to said controller unit, and being capable of accessing data recorded in a RFID tag through operating said electrical terminal device, comprising:
a SD interface, coupled to said SD card socket for signal and data communication;
a radio frequency access unit, coupled to said SD interface for reading data recorded in said RFID tag and writing data into said RFID tag; and
a memory unit, coupled to said SD interface for storing data.

2. The RFID access apparatus according to claim 1, wherein said radio frequency access unit is capable of reading and writing said RFID tag through radio frequency emitted from said radio frequency transceiver.

3. The RFID access apparatus according to claim 1, further comprises an radio frequency transceiver coupled to said SD interface for transmitting and receiving ultra high frequency signals to access said RFID tag.

4. The RFID access apparatus according to claim 1, wherein said electrical terminal device is a mobile phone.

5. The RFID access apparatus according to claim 1, wherein said electrical terminal device is a personal assistant device.

6. The RFID access apparatus according to claim 1, wherein data stored in said memory unit further comprises an electric currency.

7. A transaction method using RFID access apparatus, being capable of purchasing a product having a RFID tag, comprising the steps of:
(a) providing an electrical terminal device comprising a SD card socket;
(b) inserting a RFID access apparatus, comprising a memory unit recording an electric currency, into said SD card socket;
(c) accessing a price, stored in a RFID tag attached on a product, by operating said electrical terminal device; and
(d) making transaction.

8. The method according to claim 7, wherein said step (d) further comprises the steps of:
(d1) if said electric currency is larger than said price then deducting the amount of said price from said electric currency; and
(d2) displaying successful trading message and the residual of said electric currency on said electrical terminal device.

9. The method according to claim 8, wherein said memory unit further stores a private information of user.

10. The method according to claim 9, wherein said step (d2) further comprises a step of writing said private information in said RFID tag through operating said electrical terminal device.

11. The method according to claim 7, wherein said step (d) further comprises the steps of:
(d3) if said electric currency is smaller than said price then stopping transaction; and
(d4) displaying erroneous trading message on said electrical terminal device.

12. The method according to claim 7, wherein said RFID access apparatus further comprises a radio frequency transceiver.

13. The method according to claim 12, wherein said radio frequency transceiver is operated in bandwidth of ultra high frequency.

14. The method according to claim 7, wherein said electrical terminal device is a mobile phone.

15. The method according to claim 7, wherein said electrical terminal device is a personal assistant device.
